(19) United States
(12) Patent Application Publication
(10) Pub. No.: US 2021/0137079 A1
(43) Pub. Date: May 13, 2021

(54) Depth Control Device for a Scraper Blade for Use in Chicken Houses

(71) Applicant: H. Lamar Zimmerman, Manheim, PA (US)

(72) Inventor: H. Lamar Zimmerman, Manheim, PA (US)

(21) Appl. No.: 17/077,633

(22) Filed: Oct. 22, 2020

Related U.S. Application Data
(60) Provisional application No. 62/934,659, filed on Nov. 13, 2019.

(51) Int. Cl. A01K 31/04; A01K 1/01; A01K 1/015

(52) U.S. Cl. CPC A01K 31/04; A01K 1/0152; A01K 1/0128

(57) ABSTRACT

A scraper blade is provided with depth control disks that are formed with a narrow peripheral circumference that cuts through the accumulated chicken litter on the floor of the poultry house to engage the surface of the floor and establish a uniform residual layer of chicken litter over the floor. The depth control disks are mounted for swivel movement to accommodate changes in direction of travel of the scraper blade, and are vertically adjustable to provide a height adjustment to select the thickness of the residual layer of chicken litter left on the floor of the poultry house by the scraper blade. The scraper blade is pivotal about a central pivot to enable displacement of the chicken litter to a selected side of the scraper blade. The pivotal movement is actuated by a hydraulic cylinder.

### CROSS-REFERENCE TO RELATED APPLICATIONS

This application claims domestic priority on U.S. Provisional Patent Application Ser. No. 62/934,659, filed on Nov. 13, 2019, the content of which is incorporated herein by reference.

### FIELD OF THE INVENTION

This invention relates generally to a scraper blade used to spread and level poultry litter in poultry houses after the poultry has been removed and, more particularly, to a depth control device mounted on the scraper blade to set the blade edge at a predetermined height above the floor of the poultry house.

### BACKGROUND OF THE INVENTION

Poultry houses are used to house birds, most typically chickens, often for the production of eggs, but also for the growth of the birds for selling to poultry processors that slaughter the birds for consumption by the public. When the birds have reached a state of growth in which the birds are at a stage suitable for the sale of the birds to a poultry processor, the birds are gathered from the poultry house and shipped to the poultry processor leaving the poultry house vacant until another group of young birds are placed into the poultry house to start another cycle. During this vacant period, the poultry house needs to be cleaned so that the new group of young birds would not likely be infected by any diseases that might be associated with the group of birds just shipped off to the poultry processor.

Part of the cleaning processes is to remove the excess accumulated chicken litter and debris which can be found throughout the vacant poultry house. The cleaning process typically begins with the removal of chicken litter and debris from the parts of the poultry house above the floor. This is typically accomplished by using a blower to dislocate the chicken litter and debris from elevated portions of the poultry house so that the material falls to the floor of the poultry house. After excess chicken litter has been removed from the poultry house, a scraper blade is then utilized to distribute and level the remaining chicken litter and debris over the floor to a uniform depth.

A problem encountered in the use of the scraper blade to distribute and level chicken litter and debris along the floor of the poultry house is that the material usually covers the entire floor area and may be several inches deep. It is difficult to position the scraping edge of the scraper blade to be positioned slightly above the floor as no metering device or depth control device is available that would penetrate the chicken litter and debris to provide a base level for the setting of the position of the scraping edge. Conventional wheels simply ride on top of the level of chicken litter and debris material without providing a base level to permit the setting of the scraper blade.

Accordingly, it would be desirable to provide a depth control device that would be mounted on opposing ends of the scraper blade to penetrate the accumulation of chicken litter and debris present of the floor of a poultry house to provide a base level upon which to set the position of the scraper blade to operate close to the floor without engaging the floor and potentially causing damage to the floor. It would also be desirable to provide a depth control device that does not leave ridges in the chicken litter after the blade has leveled the chicken litter to a uniform depth.

### SUMMARY OF THE INVENTION

It is an object of this invention to overcome the disadvantages of the prior art by providing a depth control apparatus for a scraper blade that will cut through the chicken litter on top of the floor of the poultry house.

It is another object of this invention to provide a scraper blade apparatus that will leave a uniform layer of chicken litter over the floor of the poultry house.

It is a feature of this invention that the depth control apparatus for the scraper blade uses disks having a narrow peripheral circumference that will cut through the chicken litter on the floor of the poultry house.

It is an advantage of this invention that the narrow peripheral circumference of the depth control disks will engage the floor of the poultry house.

It is another advantage of this invention that the depth control disks will establish a desired depth for a uniform residue layer of chicken litter on the floor of the poultry house.

It is another feature of this invention that the depth control disks trail behind the scraper blade.

It is still another advantage of this invention that the narrow peripheral circumference of the depth control disks do not leave ridges in the layer of residue chicken litter after the blade has leveled the chicken litter to a uniform depth.

It is still another feature of this invention that the depth control disks are adjustable in height to provide a desired depth of the residue layer of chicken litter on the floor of the poultry house.

It is yet another feature of this invention that the scraper blade is centrally pivoted to permit the blade to be oriented at an angle to the direction of travel to displace chicken litter to a selected side of the scraper blade.

It is yet another advantage of this invention that the pivotal movement of the scraper blade is actuated by a hydraulic cylinder.

It is a further feature of this invention that the depth control disks are mounted for swivel movement to accommodate changes in direction of the movement of the scraper blade.

It is a further object of this invention to provide a scraper blade with a metering apparatus that is durable in construction, inexpensive of manufacture, carefree of maintenance, facile in assemblage, and simple and effective in use.

These and other objects, features and advantages are accomplished according to the instant invention by providing a scraper blade having depth control disks that are formed with a narrow peripheral circumference that cuts through the accumulated chicken litter on the floor of the poultry house to engage the surface of the floor and establish a uniform residual layer of chicken litter over the floor. The depth control disks are mounted for swivel movement to accommodate changes in direction of travel of the scraper blade, and are vertically adjustable to provide a height adjustment to select the thickness of the residual layer of chicken litter left on the floor of the poultry house by the scraper blade. The scraper blade is pivotal about a central pivot to enable displacement of the chicken litter to a selected side of the scraper blade. The pivotal movement is actuated by a hydraulic cylinder.

### BRIEF DESCRIPTION OF THE DRAWINGS

The advantages of this invention will become apparent upon consideration of the following detailed disclosure of the invention, especially when taken in conjunction with the accompanying drawings wherein:

FIG. 1 is a front elevational view of the scraper blade having left and right depth control devices incorporating the principles of the instant invention;

FIG. 2 is a left rear perspective view of the scraper blade showing the left and right depth control devices;

FIG. 3 is a top plan view of the scraper blade showing the left and right depth control devices;

FIG. 4 is a right side elevational view of the scraper blade as depicted in FIG. 1;

FIG. 5 is an upper, left, front perspective view of the scraper blade;

FIG. 6 is a top plan view of the scraper blade to view an exemplary setting of the scraper blade in an orientation with the left end of the scraper blade being forward of the right end to displace chicken litter to the right side of the scraper blade;

FIG. 7 is a top plan view of the scraper blade to view an exemplary setting of the scraper blade in an orientation with the right end of the scraper blade being forward of the left end to displace chicken litter to the left side of the scraper blade; and

FIG. 8 is upper, front perspective view of the scraper blade in the orientation depicted in FIG. 6.

### DETAILED DESCRIPTION OF THE PREFERRED EMBODIMENT

With reference to FIGS. 1-8, the general configuration of the scraper blade incorporating the principles of the instant invention can best be seen. Any references to left and right are made with regard to standing behind the scraper blade and looking in the direction of travel toward the prime mover (not shown) to which the scraper blade would be mounted for movement and operation. The scraper blade 10 includes a frame 12 that carries a blade member 11 and is pivotally connected to a hitch arm 13 at a vertical pivot 14, the hitch arm 13 terminating in a hitch mechanism 15, preferably a three-point hitch apparatus, but could also be any hitch device that permits connection of the scraper blade 10 to a prime mover, such as a tractor or a skid steer loader.

The scraper blade 10 is intended for use in a poultry house, such as a chicken house (not shown), to distribute poultry litter and level any windrows that have been formed within the structure of the chicken house. As is typical for such scraper blades 10, the hitch mechanism 15 is connected to the prime mover (not shown) so that the blade is pulled forwardly behind the prime mover to engage the accumulated chicken litter on the floor of the chicken house. With the blade angled with respect to the direction of travel, as is alternatively depicted in FIGS. 6 and 7, the chicken litter engaged by the scraper blade 10 is pushed to the trailing end of the blade member 11 where the blade member 11 aids in spreading and leveling the chicken litter along the floor of the poultry house.

As best seen in FIGS. 6-8, the frame 12 of the scraper blade 10 can be pivoted relative to the hitch arm 13 about the vertical pivot 14 to permit either end of the blade member 11 to be the trailing end from which the collected chicken litter can be discharged and displaced laterally of the leveled area over which the blade 11 travels. The pivotal movement of the frame 12 relative to the hitch arm 13 is preferably accomplished through operation of a hydraulic cylinder 30 interconnecting the hitch arm 13 and the pivot arm 17 to turn the blade 11 through the range of movement depicted in FIGS. 6 and 7.

Alternatively, the pivotal movement of the frame 12 relative to the hitch arm 13 can be accomplished manually. When the hydraulic cylinder 30 is not being used, a locking pin (not shown) passes through an opening in the hitch arm 13 to engage the pivot arm 17 and secure the selected orientation of the scraper blade 11. The pivot arm 17 can be formed with a plurality of openings (not shown) spaced in an arcuate pattern to provide a finite number of positions at which the blade 11 can be pivoted and secured. To manually re-orient the scraper blade 11, the locking pin is lifted to release the pivot arm 17 from the hitch arm 13 and the scraper blade 11 can be pushed in the selected direction to change the angle of the blade member 11 relative to the direction of travel defined by the orientation of the hitch arm 13 to attain the desired orientation of the scraper blade 11. Then the locking pin is re-inserted through the hitch arm 13 into the corresponding opening in the pivot arm 17 to lock the blade 11 in the desired position.

The left and right depth control disks 20 are located on the rearward side of the blade member 11 on opposing sides of the central pivot 14 near the left and right ends, respectively, of the blade member 11. The depth control disks 20 are formed with a cylindrical shaft 22 that provides a vertical support that terminates at the lower end thereof in a curved or bent yoke 23 that rotatably supports a disk member 25 about a horizontal axis of rotation 24.

With this configuration, the disk member 25 can caster or swivel behind the blade member 11 and accommodate changes in direction of travel of the scraper blade 10, with the horizontal axis of rotation 24 of the disk member 25 being in front of or behind the cylindrical shaft 22. As can be seen in FIGS. 2 and 4, the rear side of the blade member 11 carries a hollow receiver 26 on opposing ends thereof that are reinforced with a gusset 27 to receive the generally vertical cylindrical shaft 22. A pair of pins 28 passes through openings 29 in the hollow receiver 26 and are secured with cotter pins, nuts, or other securing devices to fix the location of the cylindrical shaft 22 within the hollow receiver 26. One skilled in the art will recognize that the cylindrical shaft 22 is formed with a plurality of openings 29 therethrough to permit a vertical adjustment of the positioning of the cylindrical shaft 22 within the hollow receiver 26. In this manner the vertical location of the disk member 25 can be located as desired to establish the desired thickness 33 of the residual layer of chicken litter after the scraper blade 10 has passed over the floor of the poultry house.

The hitch mechanism 15 can be mounted onto the three-point hitch mount at the rearward end of a tractor T, serving as the prime mover. A three-point hitch hydraulic cylinder (not shown) can be mounted between the top link of the tractor three-point hitch mount and the hitch mechanism 15 to provide an on-the-go depth control mechanism for the blade member 11. With the scraper blade 10 supported by the hitch mechanism 15 and the disk members 25, the extension of the three-point hitch hydraulic cylinder cause the blade member 11 to rotate about the horizontal axis 26 of the disk members 25 and, thereby, raise the level of the lower edge 19 of the blade member 11 relative to the floor of the poultry house. In other words, the depth at which the lower edge 19 of the scraper blade 10 operates above the floor can be controlled by the extension and contraction of the three-point hitch hydraulic cylinder.

In operation, the hitch mechanism 15 is connected in an appropriate manner to the prime mover T to permit the scraper blade 10 to be moved in a direction of travel. The angle of the blade member 11 is set by adjusting the length of the hydraulic cylinder 30 to rotate the pivot arm 17 to the desired position, or by manually positioning the scraper blade 11 and then locking the manually selected orientation by inserting the locking pin through the aligned openings in the hitch arm 13 and the pivot arm 17. The nominal height of the lower edge 19 of the blade member 11 is then set at a desired height above the floor of the chicken house by appropriately positioning the cylindrical shaft 22 of each of the left and right depth control disks 25 in the corresponding hollow receiver 26 and pinning the cylindrical shaft 22 to the hollow receiver 26 by inserting the pins 28 through the openings in the hollow receiver 26 and aligned openings 29 in the cylindrical shaft 22 and securing the pins 28 with cotter pins or the like. The operating height of the blade member 11 can be further adjusted through the operation of the three-point hitch hydraulic cylinder 35, as is described in greater detail above.

As can best be seen in FIGS. 1 and 2, the depth control disks assemblies 20 keep the lower edge 19 at a predetermined distance or height above the surface of the floor F of the chicken house shown as a gap 33 between the lower edge 19 of the blade member 11 and the lowermost edge of the disk members 25 which ride on the floor F of the poultry house. With the disk members 25 being narrow at the periphery thereof, the disk members 25 will cut through the chicken litter on the floor F of the poultry house to engage the floor of the poultry house without riding on top of the chicken litter as would occur with conventional metering wheels.

Accordingly, the operator need not be concerned about damaging the floor of the chicken house by accidentally digging the lower edge 19 of the blade member 11 into engagement with the floor. A consistent, uniform, thin residual layer of chicken litter will be distributed across the floor F after the passage of the scraper blade 10. The depth of operation of the scraper blade assembly 10 can be adjusted to increase or decrease the depth of the poultry litter on the floor F of the chicken house by adjusting the length of the three-point hitch hydraulic cylinder at the top link of the hitch mechanism 15.

It will be understood that changes in the details, materials, steps and arrangements of parts which have been described and illustrated to explain the nature of the invention will occur to and may be made by those skilled in the art upon a reading of this disclosure within the principles and scope of the invention. The foregoing description illustrates the preferred embodiment of the invention; however, concepts, as based upon the description, may be employed in other embodiments without departing from the scope of the invention.

Having thus described the invention, what is claimed is:

1. A scraper blade for spreading and leveling poultry litter along a direction of travel within a poultry house comprising:
a frame including a hitch arm terminating in a hitch mechanism adapted for connection to a prime mover, said hitch arm being movable about a vertical pivot axis;
a blade member carried by the frame for engagement of the chicken litter, said blade member being selectively positionable relative to said hitch arm to orient the blade member in a desired orientation relative to the direction of travel; and
a depth control disk mounted on said frame behind said blade member near each lateral end of said blade member to define a gap between a lower edge of said blade member and a floor of said poultry house; each said depth control disk including a disk member having a narrow cutting peripheral edge to permit said disk member to cut through said poultry litter and be engagable with the floor of said poultry house.

2. The scraper blade of claim 1 wherein each said depth control disk is rotatably mounted about a horizontal axis of rotation.

3. The scraper blade of claim 2 wherein each said depth control disk includes an upwardly extending cylindrical shaft, said frame including a hollow receiver corresponding to each respective cylindrical shaft and being affixed to said frame to receive the corresponding cylindrical shaft therein, the cylindrical shaft being secured in a selected vertical position relative to said hollow receiver.

4. The scraper blade of claim 3 wherein each cylindrical shaft is formed with a plurality of horizontal openings therethrough and being selectively alignable with corresponding holes in said hollow receiver to permit passage of pins to secure the selected vertical position of said cylindrical shaft within said hollow receiver.

5. The scraper blade of claim 3 wherein each said depth control disk includes a yoke extending between the corresponding cylindrical shaft and the horizontal axis of rotation.

6. The scraper blade of claim 5 wherein said cylindrical shaft is rotatable about a vertical axis, said horizontal axis of rotation trailing said cylindrical shaft to cause said depth control disk to caster and maintain alignment with said direction of travel

7. A depth control device for a poultry litter scraper blade, said scraper blade having a frame and a blade member with a lower edge to be positioned at a selected height about a floor of a chicken house to facilitate leveling of poultry litter in said chicken house, comprising:
a pair of disk members having a narrow cutting peripheral edge to permit said disk members to cut through said poultry litter and be engagable with the floor of said chicken house, said disk members being respectively mounted on said frame behind said blade member on opposing sides of a longitudinal centerline of said scraper blade to define said selected height of said lower edge of said blade member above said floor of said chicken house.

8. The depth control device of claim 7 wherein each said disk member is rotatably mounted in a yoke for rotation about a horizontal axis of rotation.

9. The depth control device of claim 8 wherein each said yoke terminates in a cylindrical shaft extending upwardly from said yoke, said frame having a hollow receiver corresponding to each respective cylindrical shaft and being affixed to said frame to receive the corresponding cylindrical shaft therein, the cylindrical shaft being secured in a selected position relative to said hollow receiver.

10. The depth control device of claim 9 wherein each cylindrical shaft is formed with a plurality of horizontal openings therethrough and being selectively alignable with corresponding holes in said hollow receiver to permit passage of pins to secure the selected position of said cylindrical shaft within said hollow receiver to establish the selected height of said lower edge relative to the floor of said chicken house.

11. The depth control device of claim 10 further comprising a hydraulic cylinder operatively connected to said frame to move said scraper blade about said horizontal axis of rotation to change an operative height of said scraper blade relative to said floor of said chicken house.

12. A blade assembly for distributing and leveling poultry litter over a floor member of a poultry house, comprising:
a frame including a hitch arm terminating in a hitch mechanism adapted for connection to a prime mover, said hitch arm being movable about a vertical pivot axis supported by said frame;
a blade member carried by the frame for engagement of the chicken litter, said blade member being selectively positionable relative to said hitch arm to orient the blade member in a desired orientation relative to the direction of travel;
a pair of disk members having a narrow cutting peripheral edge to permit said disk members to cut through said poultry litter and be engagable with the floor of said chicken house, said disk members being respectively mounted on said frame behind said blade member proximate to each lateral end of said blade member to define a nominal height of a lower edge of said blade member above said floor of said chicken house, said disk members being rotatable about a horizontal axis of rotation; and
a hydraulic cylinder connected to said hitch mechanism and being operable to rotate said blade member about said horizontal axes of said disk members to provide an operative depth control for said lower edge of said blade member relative to said floor of said poultry house.

13. The blade assembly of claim 12 wherein each said narrow cutting peripheral edge is located at the circumference of said disk member.

14. The blade assembly of claim 12 wherein each said disk member is rotatably mounted in a yoke for rotation about a horizontal axis of rotation, each said yoke terminating in a cylindrical shaft extending upwardly from said yoke, said frame having a hollow receiver corresponding to each respective cylindrical shaft and being affixed to said frame to receive the corresponding cylindrical shaft therein, the cylindrical shaft being secured in a selected position relative to said hollow receiver.

15. The blade assembly of claim 14 wherein each cylindrical shaft is formed with a plurality of horizontal openings therethrough and being selectively alignable with corresponding holes in said hollow receiver to permit passage of pins to secure the selected position of said cylindrical shaft within said hollow receiver to establish said nominal height of said lower edge relative to the floor of said chicken house.

16. The blade assembly of claim 14 wherein hitch mechanism is a three-point hitch apparatus mountable on a prime mover, said hydraulic cylinder being operatively connected to a top link of said three-point hitch apparatus.

17. The blade assembly of claim 13 wherein said frame further includes:
a pivot arm operably associated with a hydraulic cylinder interconnecting said hitch arm and said pivot arm to control the rotation of said blade member about a vertical pivot carried by said frame to move said blade member into a selected orientation relative to said hitch arm.
